(19) United States
(12) Patent Application Publication
(10) Pub. No.: US 2023/0384786 A1
(43) Pub. Date: Nov. 30, 2023

(54) VEHICLE TRANSPORTATION MANAGEMENT DEVICE AND IN-VEHICLE DEVICE

(71) Applicant: TOYOTA JIDOSHA KABUSHIKI KAISHA, Toyota-shi Aichi-ken (JP)

(72) Inventor: Makoto OGISO, Mishima-shi Shizuoka-ken (JP)

(73) Assignee: TOYOTA JIDOSHA KABUSHIKI KAISHA, Toyota-shi Aichi-ken (JP)

(21) Appl. No.: 18/126,718

(22) Filed: Mar. 27, 2023

(30) Foreign Application Priority Data
May 30, 2022 (JP) 2022-087617

(51) Int. Cl. G05D 1/00; G06Q 10/083

(52) U.S. Cl. CPC G05D 1/0027; G05D 1/0016; G06Q 10/083

(57) ABSTRACT

In a vehicle transportation management device, a first acquisition unit acquires vehicle position information. A second acquisition unit acquires transportation plan information of the vehicle. A generation unit generates information on a place to which a worker is to move the vehicle, based on the position information of the vehicle and the transportation plan information of the vehicle. A notification unit sends a notification of the information on the place to which the vehicle is to be moved to the vehicle.

### CROSS-REFERENCE TO RELATED APPLICATION

This application claims priority to Japanese Patent Application No. 2022-087617 filed on May 30, 2022, incorporated herein by reference in its entirety.

### BACKGROUND

### 1. Technical Field

The present disclosure relates to technology for managing transportation of a vehicle.

### 2. Description of Related Art

A vehicle such as an automobile produced in a factory is loaded on a carrier car or a ship and is transported to a dealer and the like. Japanese Unexamined Patent Application Publication No. 2020-046725 (JP 2020-046725 A) discloses a vehicle transportation status management device that transmits transportation information indicating a vehicle transportation status to a management server when the vehicle transportation status deviates from a transportation plan.

### SUMMARY

A vehicle to be transported is loaded into and unloaded from a carrier car or a ship by a worker. In a vehicle loading-unloading place such as a factory or a port, a vehicle may be moved from one position to another position by a worker. Under such circumstances, it is desirable to improve working efficiency of a worker who drives a vehicle.

An object of the present disclosure is to provide a technique capable of improving work efficiency of a worker who drives a vehicle when transporting the vehicle.

In order to solve the above problems, a vehicle transportation management device according to one aspect of the present disclosure includes: a first acquisition unit that acquires position information of a vehicle; a second acquisition unit that acquires transportation plan information of the vehicle; a generation unit that generates information on a place to which a worker is to move the vehicle, based on the position information of the vehicle and the transportation plan information of the vehicle; and a notification unit that sends a notification of information on the place to which the vehicle is to be moved to the vehicle;

Another aspect of the present disclosure is an in-vehicle device. The device is an in-vehicle device that is mounted on a vehicle and that communicates with a vehicle transportation management device, the vehicle transportation management device including a generation unit that generates information on a place to which a worker is to move the vehicle based on position information of the vehicle and transportation plan information of the vehicle, and a notification unit that sends a notification of the information on the place to which the vehicle is to be moved to the vehicle. The in-vehicle device includes a communication unit that transmits the position information of the vehicle to the vehicle transportation management device and that receives the information on the place to which the vehicle is to be moved, when an ignition switch of the vehicle is turned on.

According to this disclosure, the work efficiency of the worker who drives the vehicle can be improved when transporting the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a vehicle transportation management system according to an embodiment;

FIG. 2 is a diagram for explaining an example of transportation of a plurality of vehicles managed by the vehicle transportation management system of FIG. 1;

FIG. 3 is a diagram showing a configuration of a vehicle transportation management device and an in-vehicle device in FIG. 1;

FIG. 4 is a flowchart showing a position notification process of a movement target vehicle in the vehicle transportation management device of FIG. 3;

FIG. 5 is a flowchart showing a notification process of a place to which a vehicle should be moved in the vehicle transportation management device of FIG. 3;

FIG. 6 is a flowchart showing a vehicle information providing process in the vehicle transportation management device of FIG. 3; and

FIG. 7 is a flowchart showing a process of the in-vehicle device of FIG. 3.

### DETAILED DESCRIPTION OF EMBODIMENTS

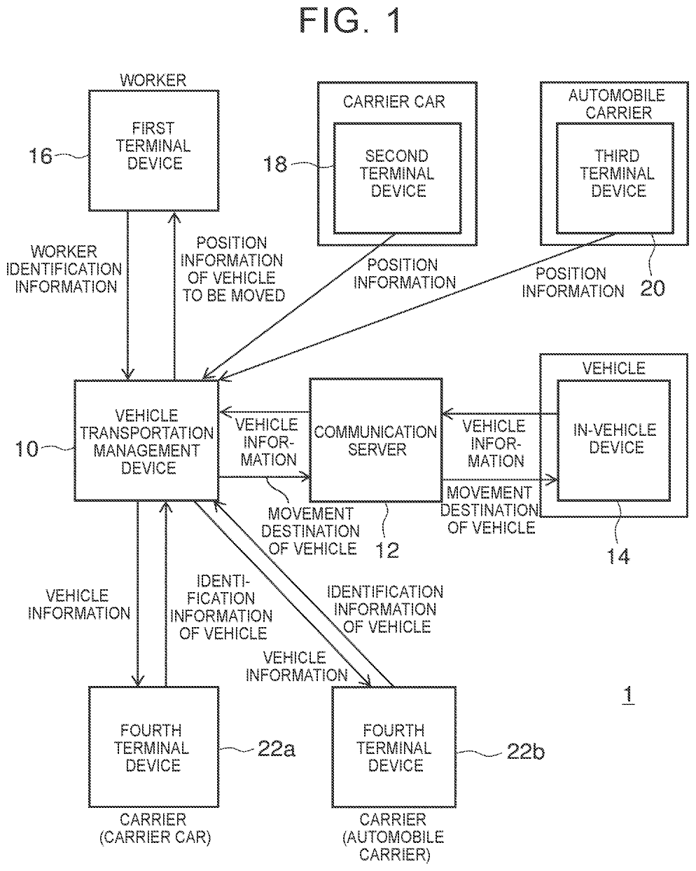

FIG. 1 is a diagram showing a configuration of a vehicle transportation management system 1 according to an embodiment. FIG. 1 also shows a flow of a part of data. The vehicle transportation management system 1 manages transportation of a plurality of vehicles manufactured at a factory to a dealer and the like. During transportation, the vehicles are loaded on and unloaded from a carrier car or a ship by being driven by a worker. In the embodiment, when the worker drives the vehicle, a display in the vehicle displays a movement destination of the vehicle so that the worker can easily grasp the movement destination of the vehicle in a short time, and it is possible to suppress the worker from mistaking the movement destination.

The vehicle transportation management system 1 includes a vehicle transportation management device 10, a communication server 12, an in-vehicle device 14, a first terminal device 16, a second terminal device 18, a third terminal device 20, a fourth terminal device 22a, and a fourth terminal device 22b. The fourth terminal device 22a and the fourth terminal device 22b are collectively called a fourth terminal device 22.

The vehicle transportation management device 10 is configured as a server and is provided, for example, in a data center of an automobile manufacturer. The communication server 12 may also be located in the data center. The vehicle transportation management device 10 and the communication server 12 may be configured integrally.

The in-vehicle device 14 is mounted in a vehicle, which is an automobile to be transported. The first terminal device 16 is carried by the worker who drives the vehicle to load or unload the vehicle on or off a carrier car or a ship.

The second terminal device 18 is mounted on a carrier car that transports a plurality of loaded vehicles by land. The third terminal device 20 is mounted on an automobile carrier that transports a plurality of loaded vehicles by sea. The fourth terminal device 22a is used by a carrier that transports vehicles by a carrier car. The fourth terminal device 22b is used by a carrier that transports vehicles by an automobile carrier.

The in-vehicle device 14 has a wireless communication function and connects to the communication server 12 via a wireless base station or wireless access point (not shown). The communication server 12, the first terminal device 16, the second terminal device 18, the third terminal device 20, and the fourth terminal device 22 are each connected to the network by wired communication or wireless communication. The vehicle transportation management device 10 is connected to the network, and the vehicle transportation management device 10 can communicate with the communication server 12, the in-vehicle device 14, the first terminal device 16, the second terminal device 18, the third terminal device 20, and the fourth terminal device 22 via the network.

Although illustration is omitted, there are a plurality of vehicles, workers, carriers, carrier cars, and automobile carriers to be transported, and a plurality of the in-vehicle devices 14, a plurality of the first terminal devices 16 to the fourth terminal devices 22a and 22b may be provided.

The in-vehicle device 14 periodically acquires vehicle information of its own vehicle and periodically transmits this vehicle information to the communication server 12 while the ignition switch is on. The acquired date and time are attached to the vehicle information. The vehicle information includes information such as the current position, the remaining amount of the drive battery that is a lithium-ion secondary battery, the vehicle size, and the vehicle weight, for example. The vehicle information may include information on the remaining amount of fuel instead of the remaining amount of the driving battery. The current position includes the latitude and the longitude. The vehicle size and the vehicle weight need only be sent once. Identification information for identifying the vehicle is attached to the transmitted vehicle information. The vehicle identification information is, for example, a vehicle identification number (hereinafter referred to as VIN). The in-vehicle device 14 neither acquires nor transmits vehicle information while the ignition switch is off. Therefore, the power consumption of the in-vehicle device 14 can be reduced. When any data is being transmitted or received when the ignition switch is turned off, the transmission or reception of the data is completed.

The communication server 12 periodically acquires the vehicle information from the in-vehicle device 14 of each of the vehicles, associates the acquired vehicle information with the vehicle identification information, and accumulates the vehicle information for each of the vehicles.

The second terminal device 18 periodically acquires the position information of the carrier car and transmits it to the vehicle transportation management device 10. The third terminal device 20 periodically acquires the position information of the automobile carrier and transmits it to the vehicle transportation management device 10.

The vehicle transportation management device 10 acquires the vehicle information of the plurality of vehicles, the position information of the carrier car, and the position information of the automobile carrier accumulated in the communication server 12, and based on the information, transports the plurality of vehicles.

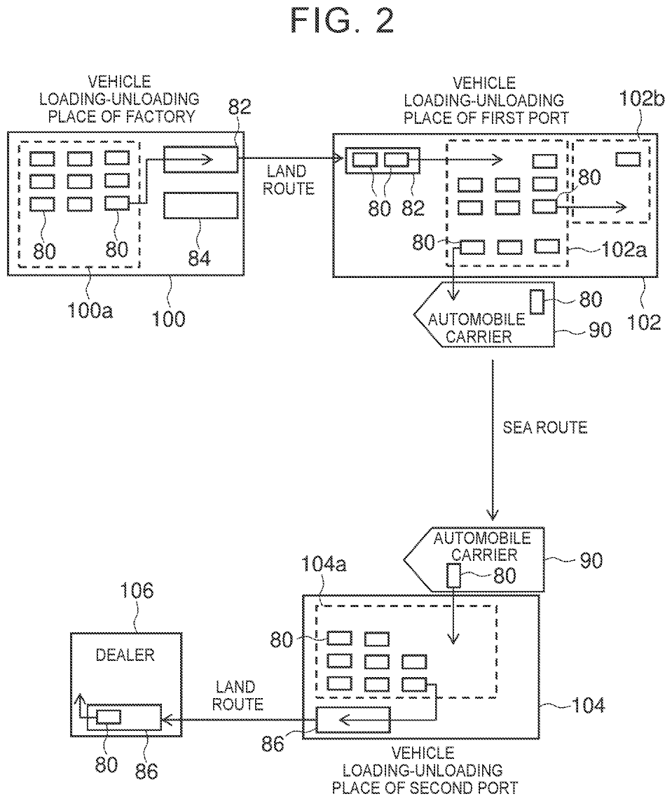

FIG. 2 is a diagram for explaining an example of transportation of the plurality of vehicles managed by the vehicle transportation management system 1 of FIG. 1. A plurality of factory-manufactured vehicles 80 are each driven to and parked at a vehicle loading-unloading place 100 of a factory. Each of the plurality of vehicles 80 in the vehicle loading-unloading place 100 of the factory is transported to a predetermined destination such as a dealership 106 by carrier cars 82, 86, and the like and an automobile carrier 90 based on a pre-made overall transport plan. There may also be vehicles that are transported to a movement destination (not shown) without using the automobile carrier 90.

The transportation plan information includes, for example, a plurality of sets of information on a date, identification information of a plurality of vehicles to be moved on the date, a transportation method, a departure point of the plurality of vehicles, and a movement destination of the plurality of vehicles. The transportation plan information is created in advance by a transportation manager or the like and is held in the vehicle transportation management device 10.

In the example of FIG. 2, the transportation plan includes, for example, information such as May 10th to May 18th as the dates, the VIN of 1000 vehicles as the vehicle identification information, the carrier car as the transportation method, the first area 100a of the vehicle loading-unloading place 100 of the factory as the departure point, and the first area 102a of the vehicle loading-unloading place 102 of the first port as the movement destination.

In addition, the transportation plan includes, for example, information such as May 20th to June 30th as dates, the VIN of 2000 vehicles as the vehicle identification information, the ship as the transportation method, the first area 102a of the vehicle loading-unloading place 102 of the first port as the departure point, and the first area 104a of the vehicle loading-unloading place 104 of the second port as the movement destination.

The transporter that transports by carrier car uses the fourth terminal device 22a to create the work plan for transport by the carrier car based on the transport plan, by the day when the transport should be started. The work plan is created for each worker and includes work details to be performed by the worker.

The worker drives the vehicle to be transported to the carrier car at the vehicle loading-unloading place of the departure point, loads the vehicle on the carrier car, drives the carrier car to the vehicle loading-unloading place of the movement destination, and unloads the vehicle there from the carrier car.

For example, the work plan includes, for each worker's identification information, the date of work, the identification information of the carrier car, the departure point of the vehicle, the movement destination of the vehicle, the identification information of the movement target vehicle, the order in which the vehicles are moved, and the identification information of the vehicle to be loaded on the second floor.

In the example of FIG. 2, the departure point of the vehicle is the first area 100a of the vehicle loading-unloading place 100 of the factory, and the movement destination of the vehicle is the first area 102a of the vehicle loading-unloading place 102 of the first port.

The fourth terminal device 22a acquires the transportation plan information from the vehicle transportation management device 10 and creates the work plan information. The fourth terminal device 22a transmits the identification information of the plurality of vehicles to be transported by the carrier car and the vehicle information request to the vehicle transportation management device 10. Upon receiving the vehicle information request, the vehicle transportation management device 10 transmits the vehicle information associated with the received vehicle identification information to the fourth terminal device 22a. Based on the vehicle size included in the vehicle information, the fourth terminal device 22a allocates the loading destination of a vehicle having a total height higher than a predetermined value to the second floor of the carrier car. When there is a vehicle with a remaining battery or remaining fuel that is less than a predetermined value, the fourth terminal device 22a may determine the loading order so that the traveling distance of the vehicle with the smaller remaining battery is shorter, within a range consistent with the transportation plan. The fourth terminal device 22a transmits the created work plan information to the vehicle transportation management device 10.

The transporter that transports by automobile carrier uses the fourth terminal device 22b to create the work plan on the transportation by the automobile carrier based on the transportation plan, by the day when the loading of vehicles on the automobile carrier should be started. For example, the work plan is created for each work group composed of a plurality of workers, and includes work details to be performed by the plurality of workers.

The plurality of workers drive the plurality of vehicles to be transported at the port of departure and load them onto the ship. At the port of destination, a plurality of separate workers drive the plurality of vehicles off the ship.

The work plan includes, for each work group, identification information of a plurality of workers, work dates, ship identification information, vehicle departure point, vehicle movement destination, vehicle identification information of a plurality of movement target vehicles, and an order in which the vehicles are moved, for example. The order in which the vehicles are moved may be determined for each group of several tens of vehicles.

In the example of FIG. 2, in the work plan of a certain work group, the departure point of the vehicle is the first area 102a of the vehicle loading-unloading place 102 of the first port, and the movement destination of the vehicle is the automobile carrier for example, a B area on the 3rd floor.

The fourth terminal device 22b acquires the transportation plan information from the vehicle transportation management device 10 and creates the work plan information. The fourth terminal device 22b transmits the identification information of the plurality of vehicles to be transported by the automobile carrier and the vehicle information request to the vehicle transportation management device 10. The vehicle transportation management device 10 transmits the vehicle information associated with the received vehicle identification information to the fourth terminal device 22b. The fourth terminal device 22b allocates the loading destination of the vehicle based on the vehicle size and vehicle weight included in the vehicle information. When there is a vehicle with a remaining battery or remaining fuel that is less than a predetermined value, the fourth terminal device 22b may determine the loading order and the loading destination so that the traveling distance of the vehicle with the smaller remaining battery and the like is shorter, within a range consistent with the transportation plan. The fourth terminal device 22b transmits the created work plan information to the vehicle transportation management device 10.

In this way, since the fourth terminal device 22 of the carrier can acquire the vehicle information, an efficient work plan can be created based on the vehicle information. In addition, by loading the vehicle so that the traveling distance of the vehicle with a small remaining battery level, etc., is short, it is possible to suppress the vehicle from being unable to travel during transportation.

The vehicle transportation management device 10 creates a transportation plan for each vehicle based on the work plan information received from the fourth terminal device 22. The transportation plan for each vehicle includes the identification information of the vehicle and the information on the departure point and the movement destination in chronological order. In the example of FIG. 2, for a vehicle, the transportation plan for each vehicle includes information such as from the first area 100a of the vehicle loading-unloading place 100 of the factory to the second floor of the carrier car, from the vehicle loading-unloading place 100 of the factory to the vehicle loading-unloading place 102 of the first port, from the carrier car in the vehicle loading-unloading place 102 off the first port to the first area 102a, from the first area 102a to the B area on the third floor of the automobile carrier 90, from the vehicle loading-unloading place 102 of the first port to the vehicle loading-unloading place 104 of the second port.

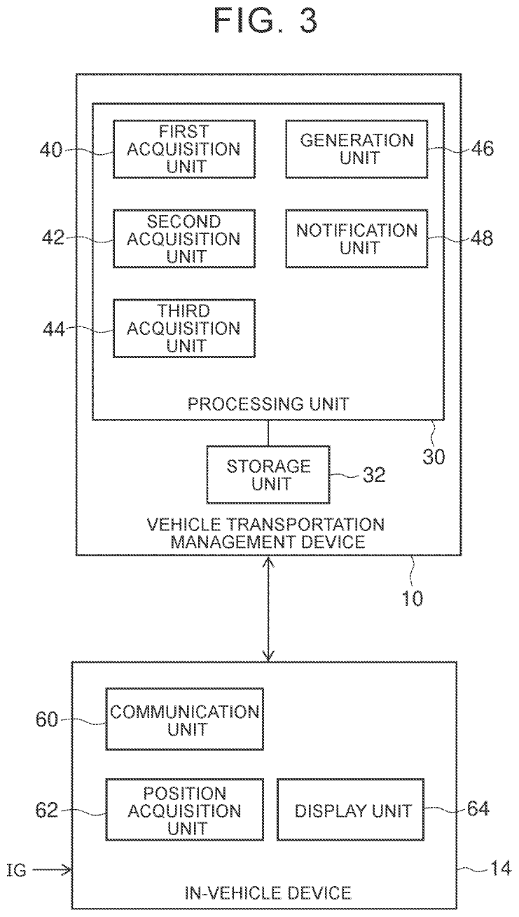

FIG. 3 shows a configuration of the vehicle transportation management device 10 and the in-vehicle device 14 in FIG. 1. The vehicle transportation management device 10 includes a processing unit 30 and a storage unit 32. The processing unit 30 includes a first acquisition unit 40, a second acquisition unit 42, a third acquisition unit 44, a generation unit 46 and a notification unit 48. The storage unit 32 stores overall transport plan information, transport plan information for each vehicle, and work plan information.

The configuration of the processing unit 30 can be implemented by a CPU, memory, and other LSIs of any computer in terms of hardware, and is implemented by a program loaded in the memory in terms of software. Here, functional blocks realized by the cooperation of the above is shown. Therefore, those skilled in the art will understand that these functional blocks can be realized in various forms by hardware only, software only, or a combination thereof.

The in-vehicle device 14 includes a communication unit 60, a position acquisition unit 62 and a display unit 64. A signal IG indicating whether the ignition switch of the vehicle is turned on or off is supplied to the in-vehicle device 14.

An example of vehicle transportation management will be described below with reference to FIGS. 1 to 3.

(1) Transportation from Vehicle Loading-Unloading Place 100 of Factory to Vehicle Loading-Unloading Place 102 of the First Port

The first terminal device 16 transmits a notification request of the position of the movement target vehicle to the vehicle transportation management device 10 in accordance with the worker at the vehicle loading-unloading place 100 of the factory. Attached to the notification request are information designating the loading work or the unloading work designated by the worker and identification information of the worker.

In the vehicle transportation management device 10, in response to the notification request specifying the loading work, the third acquisition unit 44 acquires the identification information of one or more vehicles to be moved at the vehicle loading-unloading place 100 of the factory by the worker, the order of moving the plurality of vehicles, and the transportation status, from the work plan information corresponding to the identification information of the worker. The transport status is “load into the carrier car”.

The first acquisition unit 40 acquires the position information of each of the one or more vehicles from the communication server 12 based on the vehicle identification information acquired by the third acquisition unit 44. The position information of the vehicle is the current parking position and the position when the ignition switch was last turned off.

The notification unit 48 notifies the first terminal device 16 of the worker, of the position information of each of the one or more vehicles to be moved, the order of moving the plurality of vehicles, and the transport status information. The notification unit 48 may acquire and transmit the vehicle type, the color, and the VIN of the vehicle to be moved.

The first terminal device 16 displays on the display, information on the positions of the plurality of vehicles to be moved by the worker, the order of movement, and the transportation status. The position of the vehicle to be moved is displayed, for example, by a mark such as a shape on the floor plan of the vehicle loading-unloading place 100 of the factory. The order of movement may be represented by numbers displayed on the marks. The worker can confirm the position of the vehicle displayed on the first terminal device 16, can easily grasp the position of the vehicle to be moved, and can find the vehicle in a short time. In addition, it becomes difficult to mistake the vehicle to be moved. It is easy to understand the order in which multiple vehicles are to be moved, and it is difficult to make a mistake in the loading order. Also, for example, even when the transportation plan is changed on the day of transportation and the vehicles to be moved and the order of movement are changed, the amount of time it takes to search for the vehicle to be moved in the vehicle loading-unloading place 100 of the large factory can be shortened. Therefore, work efficiency can be improved.

When the vehicle is moved, the vehicle transportation management device may update the position of the vehicle displayed on the first terminal device 16 so that the position of the vehicle that has already moved to the carrier car is not displayed.

When the worker gets into the movement target vehicle and the ignition switch is turned on, the position acquisition unit 62 of the in-vehicle device 14 receives signals from GPS satellites and derives the position of the vehicle. The communication unit transmits vehicle information to the communication server 12. The communication server 12 transmits the received vehicle information to the vehicle transportation management device 10.

In the vehicle transportation management device 10, the first acquisition unit 40 acquires the position information of the vehicle corresponding to the vehicle identification information attached to the received vehicle information, that is, the vehicle to be notified of the place to which the vehicle should be moved. That is, the first acquisition unit 40 acquires the position information of the vehicle transmitted from the vehicle when the ignition switch of the vehicle is turned on. The second acquisition unit 42 acquires the transportation plan information of the vehicle to be notified from the storage unit 32. The generation unit 46 generates information on the place to which the worker should move the vehicle and the transportation status, based on the position information of the vehicle that is the notification target and the transportation plan information of the vehicle that is the notification target. The generation unit 46 also generates a movement route from the current position of the vehicle to the place that the vehicle is to be moved. The notification unit 48 sends a notification of information regarding the place to which the vehicle should be moved, the transportation status, and the movement route, to the target vehicle.

In the example of FIG. 2, when the current position of the vehicle is the first area 100a of the vehicle loading-unloading place 100 of the factory, it is identified that the place to which the vehicle should be moved is the position of the carrier car. The place to which the vehicle should be moved includes information specifying the first or second floor of the carrier car.

In the in-vehicle device 14, the communication unit 60 receives the information regarding the place to which the vehicle should be moved, the transportation status, and the movement route from the vehicle transportation management device 10 via the communication server 12. The display unit 64 is, for example, a display of a navigation system, and displays the place to which the vehicle should be moved, the transport status, and the movement route.

The display unit 64 displays, for example, the place to which the vehicle should be moved as a mark superimposed on the floor plan of the vehicle loading-unloading place 100 of the factory. As a result, since the worker can easily know where to move the vehicle just by getting on the vehicle, the work time can be reduced. As shown in FIG. 2, even when another carrier car 84 is parked in addition to the carrier car 82, since the position of the carrier car 82 is displayed as the place to which the vehicle should be moved, mistakes of loading is less likely to occur.

In the vehicle transportation management device 10, when the current position of the vehicle deviates from the transportation plan, the notification unit 48 sends a notification of a warning that the movement destination is wrong and the place to which the vehicle should be moved to the vehicle. For example, when the current position of the vehicle is separated from the movement route by a predetermined distance or more, or when the current position of the vehicle is the position of another carrier car, it may be determined that there is deviation from the transport plan.

When the notification of the warning is sent, the display unit 64 of the in-vehicle device 14 displays the warning and the place to which the vehicle should be moved. The in-vehicle device 14 may output the warning by sound. This allows the worker to know that he or she has made a mistake in the movement destination.

When the vehicle arrives at the place to which the vehicle should be moved and the ignition switch is turned off, the in-vehicle device 14 stops acquiring and transmitting the position information. In other words, the position is determined when loading, that is, when the worker gets off the vehicle. Since the position information and the like are transmitted only when the ignition switch is turned on, the power consumption of the in-vehicle device 14 can be reduced.

The worker repeats the above-described loading operation, loads all the vehicles to be moved into the carrier car, and then drives the carrier car.

During transportation by carrier car, the in-vehicle device 14 does not transmit the position information. The second terminal device 18 of the carrier car periodically acquires the position information of the carrier car and transmits the position information to the vehicle transportation management device 10. The vehicle transportation management device 10 warns the second terminal device 18 and the transportation manager when the current position of the carrier car deviates from the transportation plan. The warning allows the carrier car driver to transport towards the correct destination.

When the carrier car 82 arrives at the vehicle loading-unloading place 102 of the first port, the worker that is the driver unloads the vehicle from the carrier car 82. For example, when it is known that only some of the vehicles will be unloaded, the worker may operate the first terminal device 16 as described above to transmit a notification request of the positions of the movement target vehicle. In this case, the worker designates unloading work in response to the notification request. The vehicle transportation management device acquires the identification information of the vehicle that the worker should move from the carrier car and the transportation status, from the work plan information corresponding to the worker's identification information. The transport status is “unload from carrier car”. The vehicle transportation management device 10 acquires vehicle position information from the communication server 12 based on the acquired vehicle identification information. The position information of the vehicle is the position when the vehicle is loaded into the carrier car and the ignition switch is turned off. Therefore, the first terminal device 16 converts the position of the vehicle to be moved into a position within the carrier car and displays it on the carrier car floor plan. The position information may include altitude and may indicate the first or second floor based on the altitude.

Since the process of the in-vehicle device 14 is basically the same as described above, the differences will be mainly described. When the worker gets into the movement target vehicle and the ignition switch is turned on, the in-vehicle device 14 transmits the vehicle information to the vehicle transportation management device 10, and receives information about the place to which the vehicle should be moved and the like from the vehicle transportation management device 10. In the example of FIG. 2, the place to which the vehicle should be moved is identified as the first area 102a of the loading-unloading place 102 of the first port.

In the in-vehicle device 14, the place to which the vehicle should be moved is indicated by a mark superimposed on the floor plan of the vehicle loading-unloading place 102 of the first port, for example. The worker drives the vehicle to unload it from the carrier car, travels to the first area 102a, and parks the vehicle.

(2) Transportation from the Vehicle Loading-Unloading Place 102 of First Port to Vehicle Loading-Unloading Place 104 of Second Port

Since the process of the first terminal device 16 is basically the same as described above, the differences will be mainly described. The first terminal device 16 transmits a notification request of the position of the movement target vehicle to the vehicle transportation management device 10 in accordance with the worker at the vehicle loading-unloading place 102 of the first port. In this case, the worker may specify loading work in response to the notification request.

The vehicle transportation management device 10 acquires, from the work plan information corresponding to the worker's identification information, the identification information of the plurality of vehicles to be moved by the worker at the vehicle loading-unloading place 102 of the first port, and the order in which the vehicles are to be moved, and the transportation status. The transportation status is “loaded on ship”.

The vehicle transportation management device 10 acquires the position information of the plurality of vehicles from the communication server 12 based on the acquired identification information of the plurality of vehicles, and transmits the position information of the plurality of vehicles to be moved, the order of moving of the vehicles, and the transport status information to the first terminal device 16 of the worker. The vehicle position information is the current parking position.

The first terminal device 16 displays on the display, information on the positions of the plurality of vehicles to be moved by the plurality of workers, the order of movement, and the transportation status. Since it is assumed that the plurality of workers in the same work group sequentially move the vehicles to the same area of the automobile carrier 90, the first terminal devices 16 of the respective workers may display common information.

When the vehicle is moved, the vehicle transportation management device updates the position of the vehicle displayed on the first terminal device 16 so that the position of the vehicle that has already moved to the automobile carrier 90 is not displayed.

Since the process of the in-vehicle device 14 is also basically the same as described above, the differences will be mainly described. When the worker gets into the movement target vehicle and the ignition switch is turned on, the in-vehicle device 14 transmits the vehicle information, receives and displays the information on the place to which the vehicle should be moved, and the like. In the example of FIG. 2, when the current position of the vehicle is in the first area 102a of the vehicle loading-unloading place 102 of the first port, the place to which the vehicle should be moved is identified as the area B on the 3rd floor of the automobile carrier. The vehicle transportation management device 10 generates a movement route from the current position of the vehicle to the B area on the third floor of the automobile carrier 90 and transmits it to the in-vehicle device 14. The worker confirms the information displayed on the display in the vehicle, drives the vehicle, travels to the B area on the third floor of the automobile carrier 90, and parks the vehicle.

Here, it is assumed that inside the ship, the in-vehicle device 14 cannot receive signals from GPS satellites. To address this, multiple wireless access points are installed on each floor in the ship. The installation intervals of the wireless access points are appropriately determined in accordance with the required positional accuracy. When the ignition switch of the vehicle is turned on and the position acquisition unit 62 of the in-vehicle device 14 cannot receive signals from the GPS satellites, the communication unit 60 connects to a nearby wireless access point by WiFi (registered trademark) communication and acquires information for identifying the connected wireless access point. The position acquisition unit 62 acquires the position information of the connected wireless access point as the position information of the vehicle, based on the identification information of the wireless access point and a predetermined database. The predetermined database holds the identification information and the position information of the wireless access points in association with each other. When the vehicle is parked inside a building at the vehicle loading-unloading place and signals cannot be received from the GPS satellites, a plurality of wireless access points may be installed inside the building as well.

After all vehicles to be moved have been loaded onto automobile carrier 90, the automobile carrier 90 departs for the second port.

During transportation by the automobile carrier 90, the in-vehicle device 14 does not transmit the position information. The third terminal device 20 periodically acquires the position information of the automobile carrier 90 and transmits the position information to the vehicle transportation management device 10. The vehicle transportation management device 10 warns the third terminal device 20 and the transportation manager when the current position of the automobile carrier 90 deviates from the transportation plan. In response to the warning, the operator of automobile carrier 90 can perform transportation toward the correct destination.

When the automobile carrier 90 arrives at the vehicle loading-unloading place 104 of the second port, the plurality of workers unload the vehicles from the automobile carrier 90. The worker operates the first terminal device 16 as described above to transmit a notification request for the position of the movement target vehicle. In this case, the worker may specify unloading work in response to the notification request. The vehicle transportation management device 10 acquires the identification information of the vehicle that the worker should move from the automobile carrier 90 and the transportation status, from the work plan information corresponding to the worker's identification information. The transport status is “unloaded from ship”. The vehicle transportation management device acquires vehicle position information from the communication server 12 based on the acquired vehicle identification information. The position information of the vehicle is the position when the vehicle is loaded into the ship and the ignition switch is turned off. Therefore, the first terminal device 16 converts the position of the vehicle to be moved into the position inside the ship and displays it on the ship's floor plan.

Since the process of the in-vehicle device 14 is also basically the same as described above, the differences will be mainly described. When the worker gets into the movement target vehicle and the ignition switch is turned on, the in-vehicle device 14 transmits the vehicle information, receives the information on the place to which the vehicle should be moved, and the like. In the example of FIG. 2, the place to which the vehicle should be moved is identified as the first area 104a of the loading-unloading place 104. In the in-vehicle device 14, the place to which the vehicle should be moved is displayed, for example, superimposed on the floor plan of the loading-unloading place 104. The worker drives the vehicle to unload it from the ship, travels to the first area 104a, and parks the vehicle.

A process during transportation from the vehicle loading-unloading place 104 of the second port to the dealer can also be performed as described above.

(3) Movement within Vehicle Loading-Unloading Place 102 of First Port

Due to the delay in the arrival of a ship bound for a certain destination, there is a cases in which it is necessary to move the vehicles that were scheduled to be loaded onto the ship within the vehicle loading-unloading place 102 of the first port and make space for the vehicles that are to be loaded onto another ship first.

In this case, an additional transportation plan is created. In addition, the transportation plan includes, for example, information such as May 25th as the date, the VIN of 100 vehicles as the vehicle identification information, the own vehicle as the transportation method, the first area 102a of the vehicle loading-unloading place 102 of the first port as the departure point, and the second area 102b of the vehicle loading-unloading place 102 of the first port as the movement destination.

The carrier that transports by the automobile carrier prepares a work plan for movement within the port based on the transportation plan by using the fourth terminal device 22b. This work plan may be prepared by the transportation manager.

The worker drives the vehicle to be transported in the first area 102a and moves to the second area 102b. The work plan includes, for example, for each worker's identification information, the work date, the departure point of the vehicle, the movement destination of the vehicle, the identification information of the movement target vehicle, and the order of moving the vehicles.

Since the process of the first terminal device 16 is basically the same as described above, the differences will be mainly described. The worker operates the first terminal device 16 to transmit a notification request for the position of the movement target vehicle. The vehicle transportation management device 10 acquires the identification information of the vehicle that the worker should move, the order of moving the vehicles, and the transportation status, from the work plan information corresponding to the worker's identification information, acquires the position information of the plurality of vehicles to be moved, and transmits the above to the first terminal device 16 of the worker. The transportation status is “moving within the vehicle loading-unloading place”. The first terminal device 16 displays the received information.

Since the process of the in-vehicle device 14 is also basically the same as described above, the differences will be mainly described. When the worker gets into the movement target vehicle and the ignition switch is turned on, the in-vehicle device 14 transmits the vehicle information, receives and displays the information on the place to which the vehicle should be moved, and the like. In the example of FIG. 2, the place to which the vehicle should be moved is identified as the second area 102b of the vehicle loading-unloading place 102 of the first port. The worker drives the vehicle to the second area 102b and parks the vehicle.

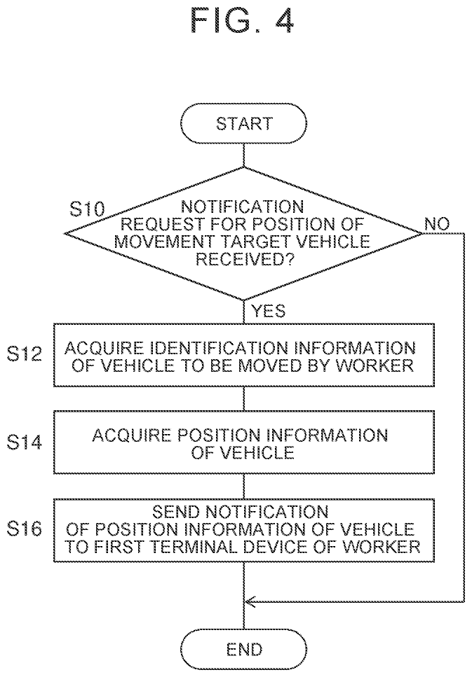

Next, the overall operation of the vehicle transportation management system 1 configured as above will be described. FIG. 4 is a flowchart showing a position notification process of the movement target vehicle in the vehicle transportation management device 10 of FIG. 3. The processing of FIG. 4 is performed periodically. When a notification request for the position of the vehicle that is the movement target is received from the first terminal device 16 of the worker (Y in S10), the third acquisition unit 44 acquires the identification information of the vehicle to which the worker should move (S12), and the first acquisition unit 40 acquires the position information of the vehicle based on the acquired identification information (S14). The notification unit 48 sends a notification of the position information of the vehicle to the first terminal device 16 of the worker (S16), and ends the process. When the notification request of the position of the movement target vehicle is not received (N of S10), the process is ended.

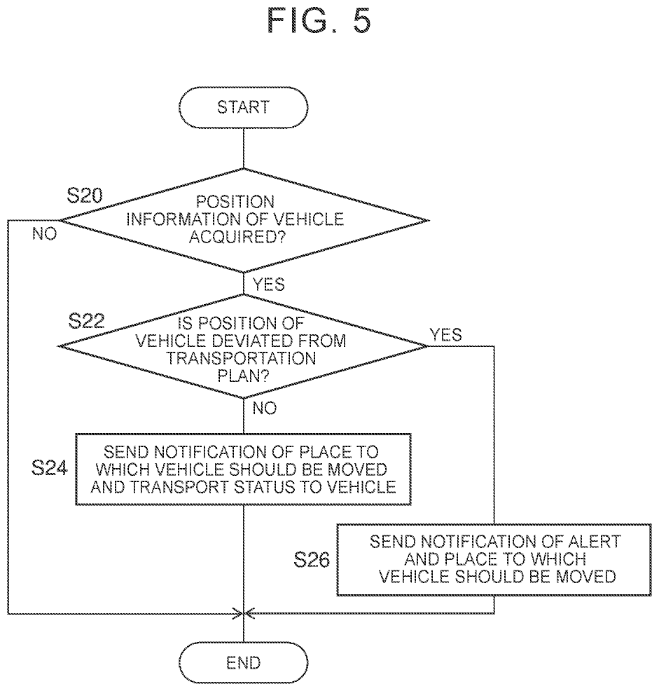

FIG. 5 is a flowchart showing a notification process of a place to which the vehicle should be moved in the vehicle transportation management device 10 of FIG. 3. The process of FIG. 5 is performed periodically. When the first acquisition unit 40 acquires the position information of the vehicle (Y of S20), in a case in which the position of the vehicle does not deviate from the transportation plan (N of S22), the notification unit 48 sends a notification of the place to which the vehicle should be moved and the transport status to the vehicle (S24), and the process is ended. When the position of the vehicle deviates from the transportation plan (Y of S22), the notification unit 48 sends a notification of a warning and the place to which the vehicle should be moved (S26), and the process is ended. When the first acquisition unit 40 has not acquired the position information of the vehicle (N of S20), the process is ended.

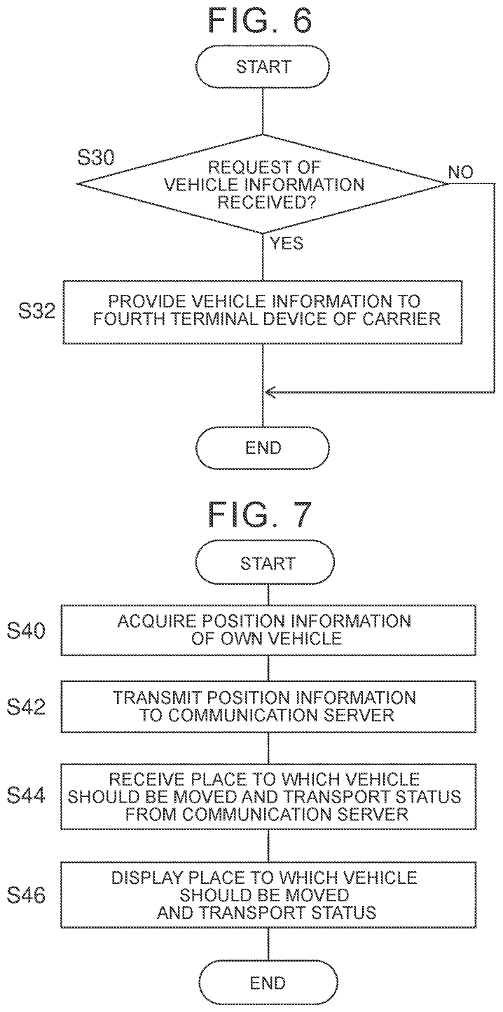

FIG. 6 is a flowchart showing a vehicle information providing process in the vehicle transportation management device 10 of FIG. 3. The process of FIG. 6 is performed periodically. When the vehicle information request is received (Y of S30), the vehicle transportation management device 10 provides the vehicle information to the carrier's fourth terminal device 22 (S32), and the process is ended. When the request for vehicle information has not been received (N of S30), the process is ended.

FIG. 7 is a flowchart showing a process of the in-vehicle device 14 of FIG. 3. The process of FIG. 7 is periodically performed while the ignition switch is turned on. The position acquisition unit 62 acquires the position information of the own vehicle (S40), and the communication unit 60 transmits the position information to the communication server 12 (S42). The communication unit 60 receives the place to which the vehicle should be moved and the transportation status from the communication server 12 (S44), the display unit 64 displays the place to which the vehicle should be moved and the transportation status (S46), and the process is ended.

According to the embodiment, since a notification of the information on the place to which the worker should move the vehicle is sent to the vehicle, the worker riding the vehicle can easily grasp the details of the work to move the vehicle. Therefore, it becomes difficult to make a mistake in the content of the movement work, the work time of the worker can be shortened, and the work efficiency can be improved. The worker is less likely to mistake the movement destination of the vehicle.

In addition, since the transportation manager can acquire the position information of the plurality of vehicles collected by the vehicle transportation management device 10, the worker does not need to input the position of the vehicle into the terminal at the relay point, and man-hours can be reduced. In addition, since the transportation manager can always grasp the current transportation status of the vehicle, in the event of a transportation delay, the transportation manager can quickly notify the dealer or the like of the change in the scheduled arrival date. In addition, it is possible to improve the accuracy of placing an order with the carrier, and reduce the waiting time at the port or the like.

The present disclosure has been described above based on the embodiments. The embodiment is just an example, and it is understood by those skilled in the art that various modifications are possible for combinations of each of these components and of each processing process, and that such modifications are also within the scope of the present disclosure.

For example, among the functions of the vehicle transportation management device 10, the function of generating the information regarding the place to which the worker should move the vehicle and sending a notification of the information to the vehicle may be provided in the in-vehicle device 14 of the vehicle. In this case, the second acquisition unit 42, the generation unit 46, and the notification unit 48 are provided in the in-vehicle device 14. The second acquisition unit 42 acquires the vehicle transportation plan information from the vehicle transportation management device 10. The notification unit 48 sends a notification of the information regarding the place to which the vehicle should be moved to the vehicle, more specifically, the worker who is the driver of the vehicle. In this modification, the degree of freedom in the configuration of the vehicle transportation management system 1 can be improved.

What is claimed is:

1. A vehicle transportation management device comprising:
a first acquisition unit that acquires position information of a vehicle;
a second acquisition unit that acquires transportation plan information of the vehicle;
a generation unit that generates information on a place to which a worker is to move the vehicle, based on the position information of the vehicle and the transportation plan information of the vehicle; and
a notification unit that sends a notification of information on the place to which the vehicle is to be moved to the vehicle;

2. The vehicle transportation management device according to claim 1, wherein the first acquisition unit acquires the position information of the vehicle transmitted from the vehicle when an ignition switch of the vehicle is turned on.

3. The vehicle transportation management device according to claim 1,
wherein the vehicle transportation management device includes a third acquisition unit that acquires identification information of one or more vehicles that the worker is to move,
wherein the first acquisition unit acquires position information of each of the one or more vehicles, and
wherein the notification unit sends a notification of the position information of each of the one or more vehicles to a terminal device of the worker.

4. The vehicle transportation management device according to claim 3,
wherein the third acquisition unit acquires, with respect to a plurality of vehicles to be moved by the worker, an order of moving the plurality of vehicles, and
wherein the notification unit sends a notification of the order of moving the plurality of vehicles to the terminal device of the worker.

5. An in-vehicle device that is mounted on a vehicle and that communicates with a vehicle transportation management device, the vehicle transportation management device including a generation unit that generates information on a place to which a worker is to move the vehicle based on position information of the vehicle and transportation plan information of the vehicle, and a notification unit that sends a notification of the information on the place to which the vehicle is to be moved to the vehicle, the in-vehicle device comprising
a communication unit that transmits the position information of the vehicle to the vehicle transportation management device and that receives the information on the place to which the vehicle is to be moved, when an ignition switch of the vehicle is turned on.
